(19) United States
(12) Patent Application Publication
(10) Pub. No.: US 2008/0120285 A1
(43) Pub. Date: May 22, 2008

(54) SYSTEMS, METHODS, AND COMPUTER READABLE MEDIUMS FOR DISPLAYING CUSTOMIZED INFORMATION IN A TICKER GUI ON A VIDEO DISPLAY DEVICE

(75) Inventor: John Ruckart, Atlanta, GA (US)

Correspondence Address: CANTOR COLBURN LLP - BELLSOUTH, 20 Church Street, 22nd Floor, Hartford, CT, 06103, US

(73) Assignee: BELLSOUTH INTELLECTUAL PROPERTY CORPORATION, Wilmington, DE (US)

(21) Appl. No.: 11/560,646

(22) Filed: Nov. 16, 2006

(51) Int. Cl. G06F 7/06; G06F 3/048; G06F 17/30

(52) U.S. Cl. 707/5; 715/774; 707/E17.001; 707/E17.017

(57) ABSTRACT

Systems, methods, and computer readable mediums for displaying customized information in a ticker GUI on a video display device are provided. In one exemplary method, the method includes receiving an indication of at least one type of information to be displayed from a plurality of information types in the ticker GUI. The method further includes receiving information from an information source. The method further includes determining if the information corresponds to the at least one type of information. The method further includes providing the received information for display in the ticker GUI when the received information corresponds to the at least one type of information.

### FIELD OF INVENTION

The present application relates to systems, methods, and computer readable mediums for displaying customized information in a ticker graphical user interface (GUI) on a video display device.

### BACKGROUND

Ticker regions have been displayed on a bottom portion of a video display device screen. A ticker region generally displays either stock quote information or news updates. A problem associated with the ticker region is that the viewer views a lot of information that they are not interested in viewing.

### SUMMARY OF THE INVENTION

A method for displaying customized information in a ticker GUI on a video display device in accordance with an exemplary embodiment is provided. The method includes receiving an indication of at least one type of information to be displayed from a plurality of information types in the ticker GUI. The method further includes receiving information from an information source. The method further includes determining if the information corresponds to the at least one type of information. The method further includes providing the received information for display in the ticker GUI when the received information corresponds to the at least one type of information.

A system for displaying customized information in a ticker GUI on a video display device in accordance with another exemplary embodiment is provided. The system includes an interface configured to allow a user to indicate at least one type of information to be displayed from a plurality of information types in the ticker GUI. The system further includes a set-top box configured to receive information from an information source. The set-top box is further configured to determine if the information corresponds to the at least one type of information. The set-top box is further configured to provide the received information for display in the ticker GUI when the received information corresponds to the at least one type of information.

A computer readable medium having computer-executable instructions for performing a method of displaying customized information in a ticker GUI on a video display device in accordance with another exemplary embodiment is provided. The method includes receiving an indication of at least one type of information to be displayed from a plurality of information types in the ticker GUI. The method further includes receiving information from an information source. The method further includes determining if the information corresponds to the at least one type of information. The method further includes providing the received information for display in the ticker GUI when the received information corresponds to the at least one type of information.

### BRIEF DESCRIPTION OF THE DRAWINGS

FIG. 1 is a schematic of a system for displaying customized information in a ticker GUI on a video display device;

FIG. 2 is a schematic of a display option GUI generated by the system of FIG. 1;

FIGS. 3-5 are schematics of an exemplary ticker GUI generated by the system of FIG. 1; and

FIGS. 6-7 are flowcharts of a method for displaying customized information in a ticker GUI on a video display device in accordance with another exemplary embodiment.

### DETAILED DESCRIPTION OF THE INVENTION

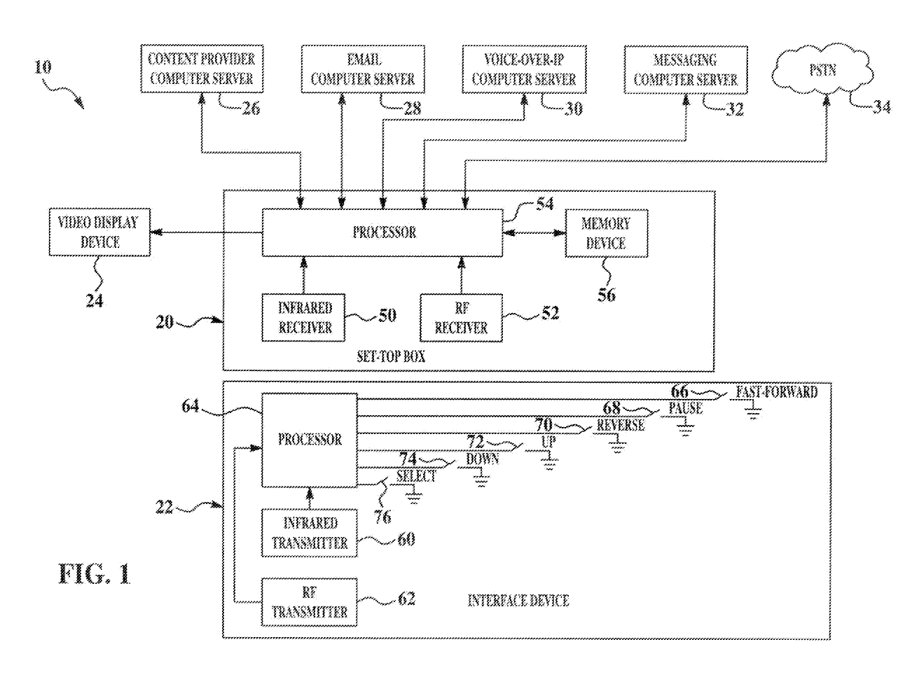

Referring to FIG. 1, a system 10 for displaying customized information in a ticker GUI is illustrated. The system 10 includes a set-top box 20, an interface device such as a hand-held device 22, a video display device 24, a content provider computer server 26, an email computer server 28, a voice-over-IP computer server 30, a massaging computer server 32, and a public switch telephone network (PSTN) 34. For purposes of understanding, an information source is any device, system, software application, or combination thereof that can provide information or data. For example, the servers 26, 28, 30, 32 and PSTN are information sources.

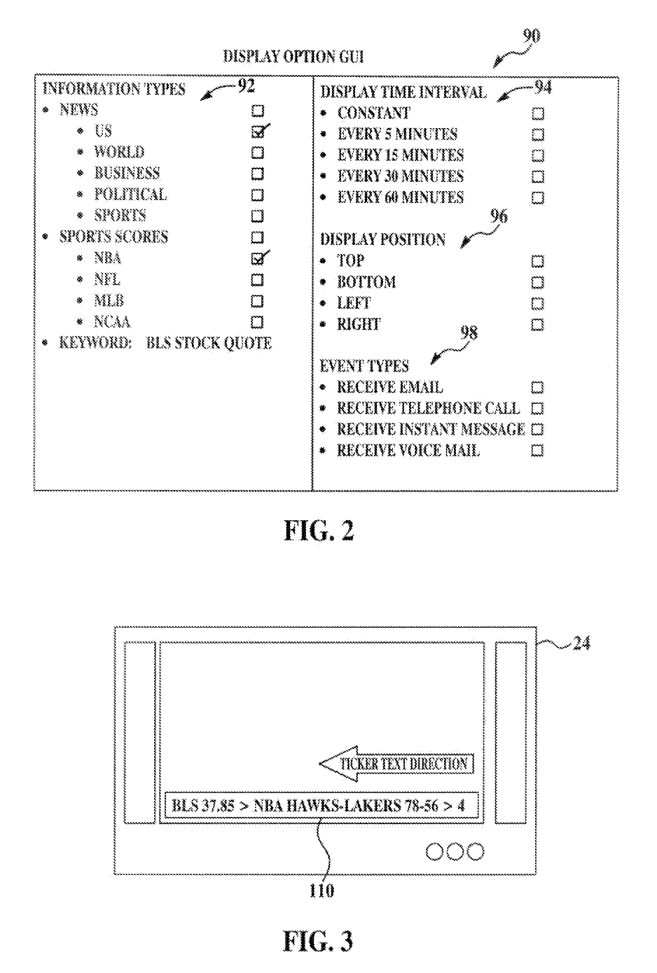

Referring to FIGS. 1 and 2, the set-top box 20 is provided to generate a display option GUI 90 on the video display device 24 to allow a user to select (i) information types that the user is interested in viewing, (ii) a display time interval between successive displays of information on the ticker GUI 110, (iii) a display position of the ticker GUI 110, and (iv) event types that have associated information that the user is interested in viewing on a ticker GUI 110. The set-top box 20 includes an infrared receiver 50, and RF receiver 52, a processor 54, and a memory 56. It is noted that in alternative embodiments, the set-top box 20 can operably communicate with other devices utilizing one or more of a DSL line, a coaxial line, a wifi interface, a WiMax interface, an Ethernet interface, an a cellular interface. Further, the set-top box 20 can receive digital and/or analog broadcasts, including video signals from an information source.

Referring to FIG. 2, in one exemplary embodiment, the display option GUI 110 has an information types section 92, a display time interval section 94, a display position section 96, and an event types section 98. The information types section 92 includes the following information type options that the user can select to view in the ticker GUI 110: (i) all news, (ii) U.S. news, (iii) world news, (iv) business news, (v) political news, (vi) all sports scores, (vii) NBA sports scores, (viii) NFL sports scores, (ix) MLB sports scores, (x) NCAA sports scores, and (xi) user-defined information such as stock quotes. Of course, in alternative embodiments, other information type options known to those skilled in the art could be utilized. Further, a smaller number of information type options could be utilized or a larger number of information type options could be utilized.

The display time interval section 94 includes the following display time options that a suer can select to determine when the ticker GUI 110 will display information: (i) constant, (ii) every 5 minutes, (iii) every 15 minutes, (iv) every 30 minutes, and (v) every 60 minutes. Of course, the foregoing display time options are exemplary display time options. In alternative embodiments, other display time options could be utilized.

The display position section 96 includes the following display position options that a user can select to determine where the ticker GUI 110 will be displayed: (i) top of screen, (ii) bottom screen, (iii) left of screen, and (iv) right of screen. The event types section 98 includes the following event types that a user can select to view information associated with the event types in the ticker GUI 110: (i) receive email, (ii) receive telephone call, (iii) receive instant message, and (iv) receive voice mail. Of course, the foregoing display position options are exemplary display position options. In alternative embodiments, other display position options could be utilized.

A user of the hand-held device 22 can control which selection boxes are “checked” on the GUI 90 to select which information types and/or event types are to be displayed in the ticker GUI 110. In particular, a user can close the switch 72 on the hand-held device 22 to scroll up through the selection boxes in the display option GUI 90. Further, the user can close a switch 74 on the hand-held device 22 to scroll down through the selection boxes in the display option GUI 90. Further, the user can close a switch 76 on the hand-held device 22 to select selection boxes an information type or an event type on the display option GUI 90.

Referring to FIGS. 1-3, the set-top box 20 is further provided to generate the ticker GUI 110 on the video display device 24 and the display customized information in the ticker GUI 110 from a plurality of information sources. In one exemplary embodiment, the set-top box 20 operably communicates with the content provider computer server 26, the email computer server 28, the voice-over-IP computer server 30, the massaging computer server 32, and the PSTN 34.

During operation, when the set-top box 20 receives information from the content provider computer server 26 corresponding to information a user has selected in the GUI 90 to view, the set-top box 20 displays the information in the GUI 110.

During operation, when the email computer server 28 receives an email message for a user, the email computer server 28 sends the message received by the set-top box 20 indicating the sender's email address and the subject of the email message. If the user has selected in the GUI 90 to view information associated with email messages, the set-top box 20 displays the sender's email address and the subject of the email message in the ticker GUI 110, in response to the message from the email computer server 28.

During operation, when the voice-over-IP computer server 30 receives a call for a user, the voice-over-IP computer server 30 sends a message which is received by the set-top box 20 indicating the caller's name and telephone number. If the user has selected in the GUI 90 to view information associated with voice-over-IP calls, the set-top box 20 displays the caller's name and telephone number in the ticker GUI 110, in response to the message from the voice-over-IP computer server 30.

During operation, when the massaging computer server 32 receives a voice-mail message for a user, the massaging computer sever 32 sends a message which is received by the set-top box 20 indicating the caller's name and telephone number. If the user has selected in the GUI 90 to view information associated with voice-mail messages, the set-top box 20 displays the caller's name and telephone number in the ticker GUI 110, in response to the message from the massaging computer server 32.

During operation, when the massaging computer server 32 receives an instant message for a user, the massaging computer sever 32 sends the message to the set-top box 20 indicating the message and the sender's name. If the user has selected in the GUI 90 to view information associated with instant messages, the set-top box 20 displays the message and the sender's name in the ticker GUI 110, in response to the message from the message computer server 32.

During operation, when the PSTN 34 routes a telephone call signal to a user indicating the caller's name and telephone number, the signal is received by the set-top box 20. If the user has selected in the GUI 90 to view information associated with telephone calls, the set-top box 20 displays the caller's name and telephone number in the ticker GUI 110, in response to the signal from the PSTN 34.

Referring again to FIG. 1, the components of the set-top box 20 will be explained in further detail. The infrared receiver 50 is configured to receive infrared signals containing commands from an infrared transmitter 60 of the hand-held device 22, for making selections on the display option GUI 90 and for controlling operation of the ticker GUI 110. The RF receiver 52 is configured to received radio frequency (RF) signals containing commands from an RF transmitter 62 of the hand-held device 22, for making selections on the display option GUI 90 and for controlling the ticker GUI 110. The processor 54 is operably coupled to the infrared receiver 50, the RF receiver 52, and the memory device 56. The processor 54 is configured to execute software algorithms for performing the various operations discussed herein with respect to the set-top box 20. The memory device 56 is configured to store software algorithms and data that are utilized by the processor 54. The processor 54 operably communicates with the video display device 24 to generate the display option GUI 90 and the ticker GUI 110.

Hand-held device 22 is provided to allow a user to make selections on the display option GUI 90 and to control operation of the ticker GUI 110. The hand-held device 22 may also control other devices such as a television, a VCR, a DVR, and perform other functions not specifically identified herein. The hand-held device 22 includes the infrared transmitter 60, the RF transmitter 62, a processor 64, and switches 66, 68, 70, 72, 74, and 76. The infrared transmitter 60 is configured to transmit infrared signals containing commands to the infrared receiver 50 of the set-top box 20, for making selections on the display option GUI 90 and for controlling operation of the ticker GUI 110. The RF transmitter 62 is configured to transmit RF signals containing commands to the RF receiver 52 of the set-top box 20, for making selections on the display option GUI 90 and for controlling operation of the ticker GUI 110. The processor 64 is operably coupled to the infrared transmitter 60, the RF transmitter 62, and the switches 66, 68, 70, 72, 74, and 76. The processor 64 is configured to execute software algorithms which perform the various functions of the hand-held device 22 discussed herein. The switch 66 is provided to allow a user to fast-forward information through the ticker GUI 110 when the switch 66 is in a closed operational position. The switch 68 is provided to allow a user to pause information on the ticker GUI 110 when the switch 68 is in a closed operational position. The switch 70 is provided to allow a user to reverse the display of information in the ticker GUI 110 when the switch 70 is in a closed operational position. The switch 72 is provided to allow user to scroll upwardly through the selection boxes of the display option GUI 90 when the switch 72 is in a closed operational position. The switch 74 is provided to allow user to scroll downwardly through the selection boxes of the display option GUI 90 when the switch 74 is in a closed operational position. The switch 76 was provided to allow user to select one or more selection boxes on the display option GUI 90 when the switch 76 is in a closed operational position. It should be noted that in an alternative embodiment, the switches 66, 68, 70, 72, 74 can be implanted in software. Further, in alternative embodiments, the hand-held device 22, can communicate data utilizing other data transmission methods, other than RF transmission methods and infrared transmission methods.

The video display device 24 is provided to display the display option GUI 90 and the ticker GUI 110 in response to signals received from the set-top box 20. The video display device 24 is operably coupled to the processor 54 of the set-top box 20.

Referring to FIGS. 3-5, a brief description of one exemplary embodiment of the ticker GUI 110 will be described. For example, the ticker GUI 110 can display the information “BLS 37.85” corresponding to the BellSouth stock prices and “NBA Hawks-Lakers 78-56” corresponding to the score of the Hawks versus Lakers basketball game, when the user selects in the GUI 90 to view a BellSouth stock quote and NBA scores. The information displayed in the ticker GUI 110 scrolls in a right to left scrolling direction as shown in FIG. 3.

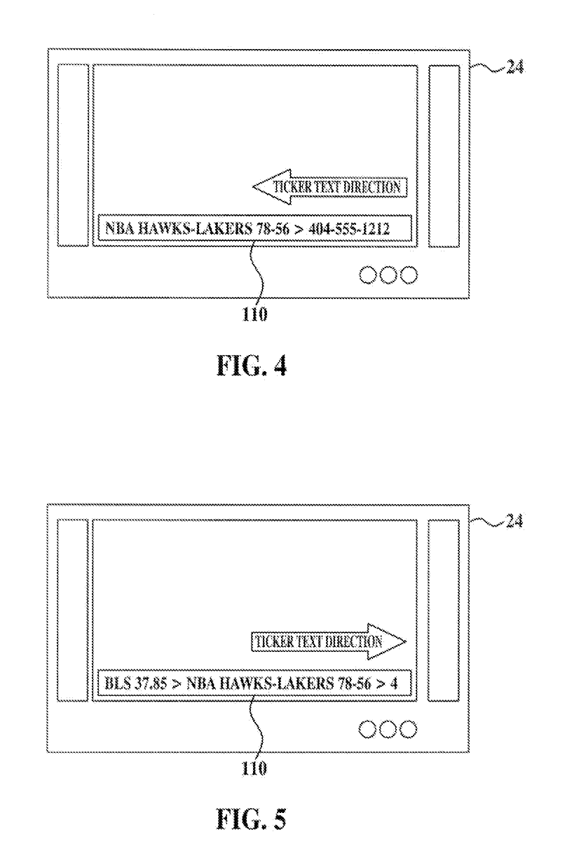

Referring to FIG. 4, the ticker GUI 110 displays the telephone number “404-555-1212” on the ticker GUI 110, when the user has selected in the GUI 90 to view information associated with received telephone calls. The information displayed in the ticker GUI 110 scrolls in a right to left scrolling direction as shown in FIG. 4. Of course, other scrolling directions can be utilized such as a left to right scrolling direction, a top to bottom scrolling direction, or a bottom to top scrolling direction.

Referring to FIG. 5, the ticker GUI 110 can redisplay the information “BLS 37.85” corresponding to the BellSouth stock prices and “NBA Hawks-Lakers 78-56” corresponding to the score of the Hawks versus Lakers basketball game, when the user closes the switch 70 on the hand-held device 22 to reverse the direction of the scrolling information in the ticker GUI 110. The information displayed in the ticker GUI 110 scrolls in a left to right scrolling direction as shown in FIG. 5.

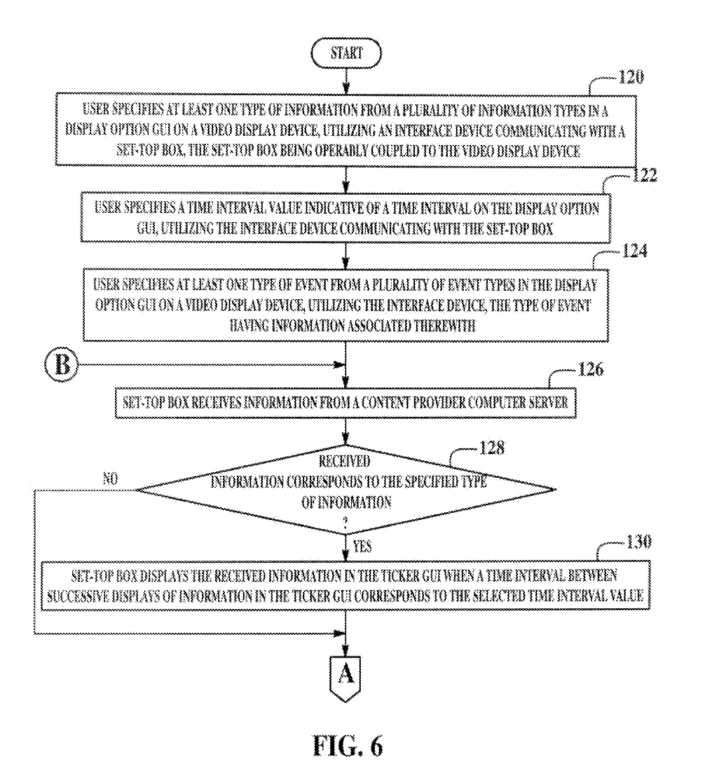

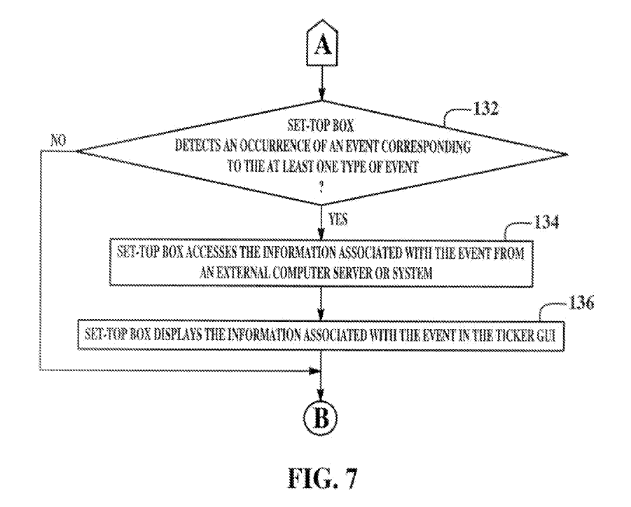

Referring to FIGS. 6-7, a method for displaying customized information in a ticker GUI on a video display device will now be explained. The following method can implemented utilizing the system 10 described above.

At operation 120, a user specifies at least one type of information from a plurality of information types in the display option GUI 90 on the video display device 24, utilizing the hand-held device 22 communicating with the set-top box 20. The set-top box 20 is operably coupled to the video display device 24.

At operation 122, the user specifies a time interval value indicative of a time interval on the display option GUI 90, utilizing the hand-held device 22 communicating with the set-top box 20.

At operation 124, the user specifies at least one type of event from a plurality of event types in the display option GUI 90 on the video display device 24 utilizing the hand-held device 22. The type of event has information associated therewith.

At operation 126, the set-top box 20 receives information from the content provider computer server 26.

At operation 128, the set-top box 20 makes a determination as to whether the received information from the content provider computer server 26 corresponds to the specified type of information that the user has selected for viewing. If the value of operation 128 equals “yes”, the method advances to operation 130. Otherwise, the method advances to operation 132.

At operation 130, the set-top box 20 displays the received information in the ticker GUI 110 when a time interval between successive displays of information in the ticker GUI 110 corresponds to the selected time interval value. After operation 130, the method advances to operation 132.

At operation 132, the set-top box 20 makes a determination as to whether an event has been detected corresponding to the at least one type of event selected by the user. If the value of operation 132 equals “yes”, the method advances to operation 134. Otherwise, the method returns to operation 126.

At operation 134, the set-top box 20 accesses the information associated with the event from an external computer server or system. For example, the set-top box 20 can access information from received messages from the email computer server 28, the voice-over-IP computer server 30, the massaging computer server 32, and the PSTN 34.

At operation 136, the set-top box 20 displays the information associated with the event in the ticker GUI 110. After operation 136, the method returns to operation 126.

The system and methods for displaying customized information in a ticker GUI provide a substantial advantage over other systems and methods. In particular, the systems and methods provide a technical effect of displaying information associated with information types and event types that a user has selected such that the user can view information in a ticker GUI that the user is interested in viewing.

The above described methods can be at least partially embodied in the form of computer-implemented processes and apparatuses for practicing those processes. In the exemplary embodiments, the methods are embodied in computer program code executed by one or more processors or controllers. The present methods may be embodied in the form of computer program code containing instructions embodied in one or more computer-readable mediums such as floppy diskettes, CD-ROMs, hard drives, flash memory, or the like, wherein, when the computer program code is loaded into and executed by a processor or controller, the processor or controlled becomes an apparatus for practicing the invention.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling with the scope of the appended claims. Moreover, the use of the terms first, second, etc. do not denote any order or importance, but rather the items first, second, etc. are used to distinguish one element from another. Further, the use of the terms a, an, etc. do not denote a limitation of quantity, but rather denote the presence of at least one of the referenced items.

What is claimed is:

1. A method for displaying customized information in a ticker GUI on a video display device, comprising:
receiving an indication of at least one type of information to be displayed from a plurality of information types in the ticker GUI;
receiving information from an information source;
determining if the information corresponds to the at least one type of information; and
providing the received information for display in the ticker GUI when the received information corresponds to the at least one type of information.

2. The method of claim 1, wherein the at least one type of information comprises at least one of U.S. news, world news, business news, political news, and sports news.

3. The method of claim 1, wherein the at least one type of information comprises sports scores.

4. The method of claim 1, wherein the at least one type of information comprises predetermined stock quotes.

5. The method of claim 1, further comprising:
receiving an indication of at least one type of event, the type of event having information associated therewith;
detecting an occurrence of an event corresponding to the at least one type event;
accessing the information associated with the event; and
providing the information associated with the event for display in the ticker GUI.

6. The method of claim 5, wherein the event comprises at least one of receiving an email message, receiving a telephone call, receiving an instant message, and receiving a voice mail message.

7. The method of claim 5, wherein the event comprises receiving an email message and the information associated with the event is a sender email address and an email subject information.

8. A system for displaying customized information in a ticker GUI on a video display device, comprising:
an interface configured to allow a user to indicate at least one type of information to be displayed from a plurality of information types in the ticker GUI; and
a set-top box configured to receive information from an information source, the set-top box further configured to determine if the information corresponds to the at least one type of information, the set-top box further configured to provide the received information for display in the ticker GUI when the received information corresponds to the at least one type of information.

9. The system of claim 8, wherein the information source comprises a content provider computer server.

10. The system of claim 8, wherein the at least one type of information comprises at least one of U.S. news, world news, business news, political news, and sports news.

11. The system of claim 8, wherein the at least one type of information comprises sports scores.

12. The system of claim 8, wherein the at least one type of information comprises predetermined stock quotes.

13. The system of claim 8, wherein the interface is further configured to allow the user to indicate at least one type of event, the type of event having information associated therewith, the set-top box further configured to detect an occurrence of an event corresponding to the at least one type event, the set-top box further configured to access the information associated with the event, the set-top box further configured to provide the information associated with the event for display in the ticker GUI.

14. The system of claim 13, wherein the event comprises at least one of receiving an email message, reeving a telephone call, reviving an instant message, and receiving a voice mail message.

15. The system of claim 13, wherein the event comprises receiving an email message and the information associated with the event is a sender email address and an email subject information.

16. A computer readable medium having computer-executable instructions for performing a method of displaying customized information in a ticker GUI on a video display device, the method comprising:
receiving an indication of at least one type of information to be displayed from a plurality of information types in the ticker GUI;
receiving information, from an information source;
determining if the information corresponds to the at least one type of information; and
providing the received information for display in the ticker GUI when the received information corresponds to the at least one type of information.

17. The computer readable medium of claim 16, wherein in at least one type of information comprises at least one of U.S. news, world news, business news, political news, and sports news.

18. The computer readable medium of claim 16, wherein the method further comprises:
receiving an indication of at least one type of event, the type of event having information associated therewith;
detecting an occurrence of an event corresponding to the at least one type event;
accessing the information associated with the event; and
providing the information associated with the event for display in the ticker GUI.

19. The computer readable medium of claim 18, wherein the event comprises at least one of receiving an email message, receiving a telephone call, receiving an instant message, and receiving a voice mail message.

20. The computer readable medium of claim 18, wherein the event comprises receiving an email message and the information associated with the event is a sender email address and an email subject information.
